(19) United States
(12) Patent Application Publication
(10) Pub. No.: US 2026/0169215 A1
(43) Pub. Date: Jun. 18, 2026

(54) PEROVSKITE OPTICAL FIBERS

(71) Applicant: QUEEN MARY UNIVERSITY OF LONDON, London, Greater London (GB)

(72) Inventors: Yongfeng ZHOU, London, Greater London (GB); Lei SU, London, Greater London (GB)

(73) Assignee: QUEEN MARY UNIVERSITY OF LONDON, London, Greater London (GB)

(21) Appl. No.: 19/102,207

(22) PCT Filed: Aug. 9, 2023
(86) PCT No.: PCT/GB2023/052111

§ 371 Date: Feb. 7, 2025

(30) Foreign Application Priority Data
Aug. 10, 2022 (GB) 2211705.5

(51) Int. Cl. G02B 6/02

(52) U.S. Cl. CPC G02B 6/02033

(57) ABSTRACT

A method for the growth of single-crystal perovskite optical fibres, the fibres having a cladding and a perovskite core, the method comprising: continuously growing the perovskite core along an axial direction of a capillary filled with perovskite precursor solution, wherein the axial directional growth of the perovskite core is realised by capillaries, which limit growth of the perovskite core in the radial direction, wherein the method is controlled by gradually changing heating position and localised contact of a heating block with the capillary, and the capillary forms the cladding of the single-crystal organometallic perovskite optical fibre.

### TECHNICAL FIELD

The present invention relates to an optical fibre having a single-crystal organometallic core, and a method of its formation.

### BACKGROUND

Organometallic halide perovskites are attractive candidates for a wide range of applications in photovoltaic and optoelectronic devices due to their simple solution preparations(1), rich chemical and structural diversities(2), large carrier mobilities(3) and tunable bandgaps(4). The optoelectronic applications of organometallic hybrid perovskites have been demonstrated in high-efficiency solar cells(5), light-emitting diodes(6), photodetectors(7), and lasers(8). More recently, increasing research evidence indicates their promising third-order nonlinear optical properties(9, 10), piezoelectric response(11) and thermoelectric properties(12). In particular, single-crystal organometallic perovskites have superior performances compared to their polycrystalline counterparts, such as high stability, low optical transmission loss, long charge-carrier lifetime and long carrier diffusion length as a result of low defect densities(13).

Several fabrication methods have then been reported for single-crystal organometallic perovskites, including temperature lowering crystallisation(14), antisolvent vapour-assisted crystallisation(13), liquid diffused separation induced crystallization(15) and inverse temperature crystallisation(16).

Semiconductor core fibers not only have a wide range of applications in optics, as sources(17), detectors(18) and nonlinear response media(19), but also emerge as versatile platforms of advanced functional fibers for multifunctional smart fabric in sensors(20), photovoltaics(21), thermoelectrics(22), piezoelectrics(23), p-n diodes(24), etc.

Several types of semiconductor materials have been used successfully to make optical fibers, including silicon(25), germanium(26), III-V compounds(27), II-VI compound(28), and chalcogenides(20). Their fabrication approaches are based primarily on thermal drawing(25), pressure assisted physical filling(29), and high-pressure chemical vapour deposition(26). Single-crystal silicon and germanium optical fibers were achieved through additional laser recrystallisation on polycrystalline fibers(30-32).

In particular, single-crystal organometallic perovskite optical fibers possess many advantages in high-speed all-fiber optoelectronics. Organometallic perovskites possess direct bandgap and low defect densities, which are efficient at emitting light(33, 34). Direct bandgap low-loss single-crystal organometallic perovskite optical fibers can be a suitable candidate for the integration of the light source into all-fiber optical networks. Moreover, the bandgap of single-crystal organometallic perovskite optical fibers can be continuously engineered by simply changing the elemental composition through the chemical precursors. In addition, the reported optoelectronic & nonlinear optical properties(3, 7, 9, 10) suggest single-crystal organometallic perovskite optical fibers are promising platforms for detectors and nonlinear optics.

By considering all these properties mentioned above, single-crystal organometallic perovskite optical fibers could be an all-round candidate in high-speed all-fiber optoelectronics, where light can be generated, modulated and detected within an optical fiber.

As is generally known in the prior art, optical fibers are transparent fibres which transmit light along their length. Optical fibers typically include a core surrounded by a transparent cladding material. The cladding typically has a lower index of refraction than the core, so that total internal reflection of light is achieved at the core-cladding interface. This enables the fiber to act as a waveguide and propagate light along its length.

Wafer-scale single-crystal organometallic perovskite thin film that realises planar growth with precise control of thickness was achieved by a lithography-assisted epitaxial inverse temperature growth method(36). Organometallic perovskite polycrystalline and monocrystalline microwires synthesised in solution have been reported(37, 38), however their lengths were on the micrometer scale and their geometric dimensions were not controllable.

Template solution growth methods using polydimethylsiloxane (PDMS) groove templates and capillaries have been developed to produce organometallic perovskite nanowires and microwires for laser applications(39, 40). Although the cross-section dimensions of these nanowires or microwires were controlled to a certain extent, they were polycrystalline perovskites and their lengths were also only on the micrometer scale.

### Problem to be Solved

Semiconductors in their optical-fiber forms are desirable. Single-crystal organometallic halide perovskites possess attractive optoelectronic properties and therefore are suitable fiber-optic platforms. However, single-crystal organometallic perovskite optical fibers have not been reported before. One of the challenges with forming single-crystal organometallic perovskite optical fibers is the challenge of one-directional single-crystal growth in solution.

Despite the potential of single-crystal organometallic perovskite materials in optoelectronic and electronic devices, single-crystal organometallic perovskite optical fibers are beyond the state-of-the-art. It is challenging to achieve the continuous one directional growth of the single-crystal organometallic perovskites in an axial direction, while limiting its growth in the radial direction and inhibiting random nucleation(35).

### SUMMARY OF INVENTION

It is an object of the present invention to alleviate the above identified problems.

According to the present invention, there is provided a method for the growth of single-crystal perovskite optical fibres, the fibres having a cladding and a perovskite core, the method comprising:
continuously growing the perovskite core along an axial direction of a capillary filled with perovskite precursor solution,
wherein the axial directional growth of the perovskite core is realised by capillaries, which limit growth of the perovskite core in the radial direction,
wherein the method is controlled by gradually changing heating position and localised contact of a heating block with the capillary, and
the capillary forms the cladding of the single-crystal organometallic perovskite optical fibre.

According to an embodiment of the present invention, the method may be a solution-processed, space-confined, inverse temperature crystallisation, localised translational heating method.

According to an embodiment of the present invention, the length of the fibre may be controlled by the heating method.

According to an embodiment of the present invention, the perovskite may be an organometallic perovskite.

According to an embodiment of the present invention, the cross section of the perovskite fibre core may correspond to an inner diameter of the capillary.

According to an embodiment of the present invention, the capillary may be made from a material which has a refractive index that is lower than the refractive index of the perovskite core.

According to an embodiment of the present invention, the cladding material may be glass or polytetrafluoroethylene.

According to the present invention there is provided a method for the growth of a single-crystal organometallic perovskite optical fibre having a core and cladding, comprising the steps of:
forming a perovskite precursor solution;
filtering the solution;
filling the perovskite precursor solution into capillary tubes;
sealing the capillary tubes at one end;
placing a heat transfer block on a hotplate, such that the heat transfer block has a line contact with the capillary;
heating the solution at a predetermined position on the capillary until a seed perovskite crystal is formed;
reducing the heating temperature such that single-crystal fibre growth of the precursor solution takes place;
translating the predetermined position according to the growth speed of the single-crystal organometallic perovskite optical fibre to ensure heating position is located at the crystal-solution interface, such that a constant temperature gradient is maintained in front of the crystal-solution interface by the changed heating position.

According to an embodiment of the present invention, the method may further comprise a step of supplying fresh precursor perovskite solution into the capillary tubes at the other end during growth of the single crystal.

According to an embodiment of the present invention, the single-crystal organometallic perovskite optical fibre may have a CH₃NH₃PbBr₃ core, and the organometallic perovskite precursor solution is formed by dissolving PbBr₂ and CH₃NH₃Brₛ (1/1 by molar, 1 M) in DMF by magnetic stirring at room temperature.

According to an embodiment of the present invention, the single-crystal organometallic perovskite optical fibres may have a CH₃NH₃PbX₃ core, wherein X is chlorine or iodine, and the precursor solution is formed by dissolving PbX₂ and CH₃NH₃X (1/1 by molar, 1 M) in DMF by magnetic stirring at room temperature.

According to an embodiment of the present invention, wherein the solution may be filtered using a PTFE filter with 0.2 μm pore size.

According to an embodiment of the present invention, the solution may be heated at the sealed end of the capillary tube to 80° C. for a few hours, such that the seed organometallic perovskite crystal is formed.

According to an embodiment of the present invention, wherein the hotplate temperature may be reduced to 60° C. such that single-crystal fibre growth of the precursor solution takes place.

According to an embodiment of the present invention, the precursor solution may be refreshed periodically during the crystal growth to produce longer organometallic perovskite optical fiber.

According to an embodiment of the present invention, the precursor solution may be refreshed when the growth rate of the crystal becomes lower than normal value.

According to an embodiment of the present invention, wherein the capillary tubes may be made of silica.

According to an embodiment of the present invention, wherein the capillary tubes may be made of PTFE.

According to an embodiment of the present invention, wherein the diameter of the capillary may be equal to or greater than 50 μm and equal to or less than 1000 μm.

According to an embodiment of the present invention, there may be provided an optical fibre manufactured according to any of the above methods.

According to the present invention, there is provided an optical fibre comprising a cladding and a core, wherein the core is a single-crystal organometallic halide perovskite.

According to an embodiment of the present invention, the cladding may be silica or PTFE.

According to an embodiment of the present invention, the core may be a single crystal CH₃NH₃PbBr₃.

According to the present invention there is provided an optical switch comprising optical fibres according to the present invention.

### BRIEF DESCRIPTION OF THE DRAWINGS

Exemplary embodiments of the invention are described below with reference to the accompanying figures, in which:

FIG. 1 is a schematic of a single-crystal organometallic perovskite optical fiber fabrication method according to an embodiment of the present invention.

FIG. 2 is a schematic illustrating the ion diffusion rate in the capillaries with different inner diameters, d.

FIGS. 3A-3D show single-crystal MAPbBr₃ perovskite optical fibers of different lengths and diameters with silica cladding formed by a method according to the present disclosure.

FIGS. 3E and 3F show single-crystal MAPbBr₃ perovskite optical fibers of different lengths and diameters with PTFE cladding.

FIG. 4 is a schematic diagram of a single-crystal organometallic perovskite optical fiber fabrication method according to an embodiment of the present invention.

FIG. 5 is a schematic diagram of a single-crystal organometallic perovskite optical fiber formed by a method according to an embodiment of the present invention.

FIG. 6A is an optical microscopy image of MAPbBr₃ perovskite fibers with silica cladding formed by a method according to an embodiment of the present invention.

FIG. 6B is an optical microscopy image of MAPbBr₃ perovskite fibers with PTFE cladding formed by a method according to an embodiment of the present invention.

FIG. 6C is an SEM image of a cross section of a 500 μm core-diameter single-crystal organometallic perovskite optical fiber with silica cladding.

FIG. 6D is an SEM image of a cross section of a 50 μm core-diameter single-crystal organometallic perovskite optical fiber with PTFE cladding.

FIG. 7A is a powder X-ray diffraction of ground MAPbBr₃ crystals taken from a 500 m perovskite core formed according to a method according to an embodiment of the present invention.

FIG. 7B is a Raman spectra of MAPbBr₃ fibers with the core diameter of 50 μm and 500 μm.

FIG. 8A-8C show the results of synchrotron XRD analysis of single-crystal organometallic perovskite optical fibers.

FIGS. 9A-9D characterise the optical properties and photoelectric performance of the single-crystal MAPbBr₃ formed by a method according to an embodiment of the present invention.

FIGS. 10A-10E illustrate the flexibility performance of a single-crystal MAPbBr₃ optical fibers with PTFE cladding.

FIG. 11A is a schematic diagram of an optical switch comprising optic fibres formed by a method according to an embodiment of the present invention.

FIG. 11B shows the performance of an all-optical switch through the free carrier plasma-dispersion effect in a perovskite optical fibre according to an embodiment of the present invention.

In the various figures, like-parts are identified by like-references.

### DETAILED DESCRIPTION OF EMBODIMENTS

According to the present invention, there is provided a method for the growth of optical fibres having a single crystal perovskite optical core. The perovskite may be an organometallic perovskite.

The method can be described as a solution-processed, space-confined, inverse temperature crystallisation method. The method allows for the growth of single-crystal organometallic perovskite optical fibers continuously along the axial direction. This is achieved by localised heating of the precursor solution, such that localised heating gradually changes as the perovskite single crystal grows along the axis of the capillary.

Capillaries are used to realise the axial directional growth of the perovskite from a precursor solution, while limiting the growth in the radial directions.

According to the present invention, a capillary is filled with the perovskite precursor solution. Crystallisation of the perovskite along the length of the fibre is controlled by varying the parameters described below. Accordingly, a perovskite single crystal is formed inside the capillary, which may be used as an optical fiber. The perovskite single crystal forms the core of the optical fiber and the capillary forms the cladding of the optical fiber. The capillary forms part of the optical fiber, meaning that it does not have to be removed after the perovskite single crystal is formed.

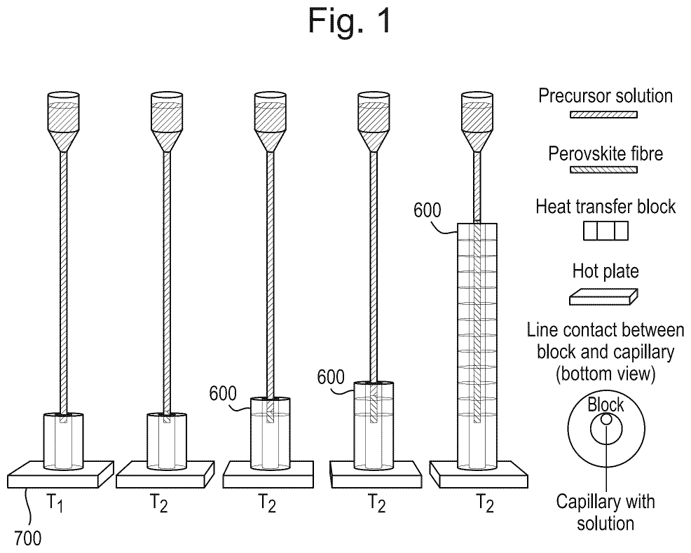

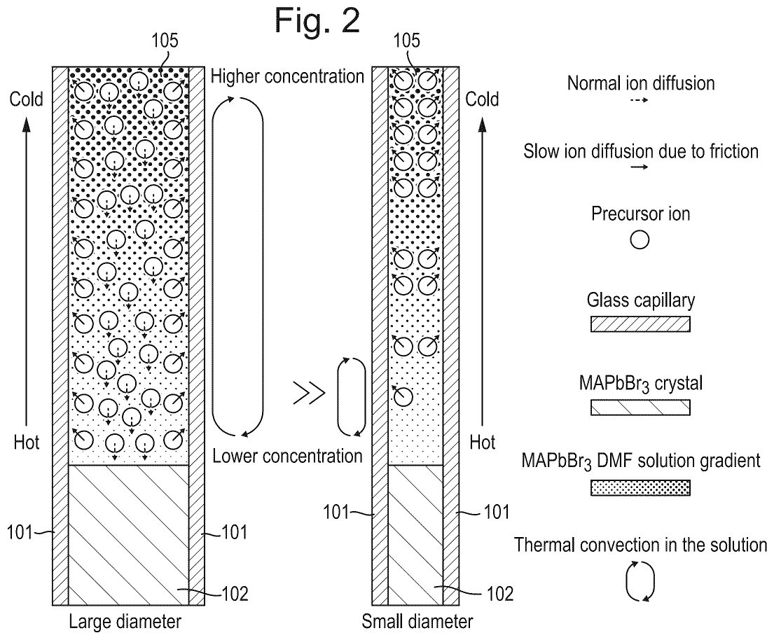

An embodiment of the method is illustrated on FIG. 1. FIG. 2 is a schematic illustrating a cross-section of the capillary 101 during growth of the perovskite single crystal. A capillary 101 is filled with a precursor solution 105. The precursor solution 105 is a precursor for an organometallic perovskite. Crystallisation of the precursor solution is controlled by controlling the heating conditions of the precursor solution 105 in the capillary 101.

The precursor solution is heated along the length of the capillary, such that the precursor solution crystallises along the length of the capillary.

By gradually changed heating position, line contact and temperature changes during the process ensure continuous growth while preventing random nucleation in the axial direction. The line contact is the line of contact between a heating element and the surface of the capillary. Alternatively, localised heating can be achieved by means of a point contact between a heating means and the capillary. The heating means may be a heat transfer block which is used to transfer heat to the precursor solution.

The length of the fiber can be controlled, and the cross section of the perovskite fiber core can be varied according to the inner diameters of the capillary 101. This method is applicable to other organometallic perovskite materials that can be processed in solution. The cladding material (i.e. the material of the capillary) can be glass or other materials. The capillary may be made from glass, polytetrafluoroethylene (PTFE), or another material. Comparing with the rigid glass capillaries, the PTFE capillaries are flexible and can be easily deformed.

The material of the capillary preferably has a refractive index which is lower than the perovskite core. This enables the formed optic fiber to act as a waveguide, because total internal reflection of light can be achieved at the cladding-core interface.

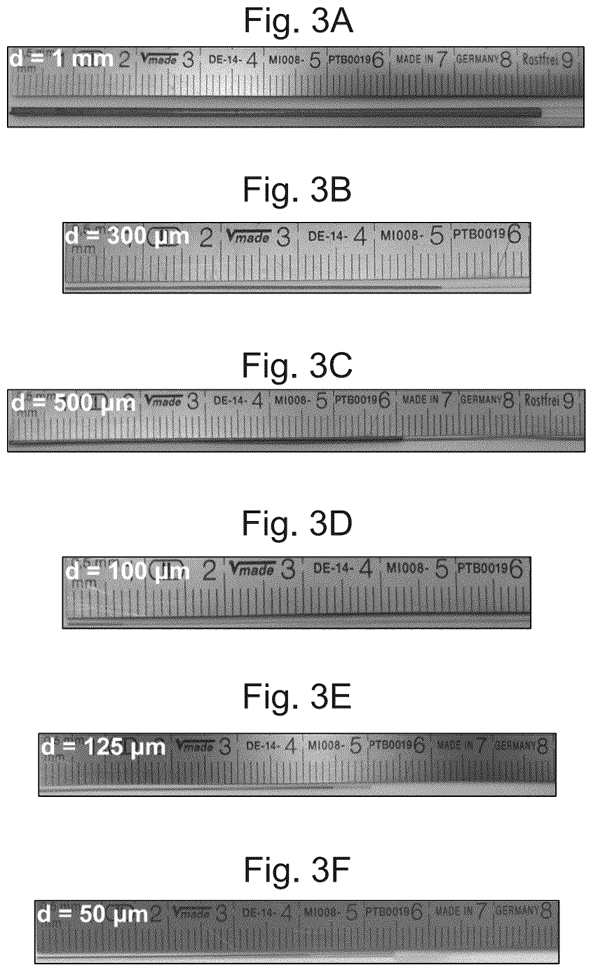

FIGS. 3A-3F show single-crystal MAPbBr₃ perovskite optical fibers of different lengths and diameters (d) fabricated according to an embodiment of the method by using silica capillaries.

For 100 μm-core-diameter single-crystal organometallic perovskite optical fibers with silica cladding, the lengths that can be currently achieved are limited to several millimeters (e.g. the 100 μm core-diameter 7 mm-long fiber in FIG. 3D). The length of the fibers with larger diameters (such as 300 μm, 500 μm and 1 mm, as shown in FIGS. 3B, 3C and 3A respectively) can grow indefinitely, in theory. The present inventors have observed that the smaller the inner diameter of the glass capillary is, the longer it takes for the organometallic perovskite fiber to grow to a certain length. For glass capillaries with an inner core-diameter (d) smaller than 300 μm, the growth rate usually decreases gradually during the crystallisation growth process until the growth finally stops.

It is believed that one factor which may explain growth dependence on the capillary diameter is the insufficient long-range transport of precursor ions along capillaries, i.e. the depleted precursors within capillaries of smaller diameters cannot be sufficiently replenished in real time for continuous crystal growth. The diffusion rate of precursor ions dissolved in the organic solvent is determined by the transport speed of solvent molecules along the capillary axial direction, which is influenced by two main mechanisms.

First, the wetting glass capillary surface with high surface energy normally attracts solvent in precursor solution, which plays a negative role for ion diffusion(41, 42). The glass capillaries with their large attraction force to solvent molecules drag down the speed of solvent molecule transport(43).

Second, in contrast to the attraction force that slows down the solvent transport, thermal convection in the solution caused by temperature gradients facilitate the precursor ion diffusion. When the capillary diameter is large enough, even though the solution transport near the capillary surface is dragged down by the attraction force, effective long-range thermal convection can still be achieved within the capillary for the precursor solution farther away from the inner glass capillary surface, as shown in the large-diameter capillary shown on the left-hand side of FIG. 2. When the capillary diameter is too small (for example, less than 300 μm), the attraction force induced by the inner glass capillary surface affects most of the solvent molecules within the capillary and drags down the speed of the solution transport (see the small-diameter capillary shown on the right-hand side of FIG. 2; therefore, the thermal convection works only over a short distance, which results in insufficient ion diffusion to replenish the depleted precursor ions

This growth limitation could be improved by using non-wetting cladding materials or introducing a non-wetting film on the inner surface of the capillary, which could reduce or eliminate the attraction force to solvent molecules.

Accordingly, the capillary 101 may be made from a material which is non-wetting. Alternatively, the capillary 101 may have a non-wetting film applied to the inner surface of the capillary.

In an embodiment, the capillary may be formed of non-wetting polytetrafluoroethylene (PTFE). Accordingly, the above-mentioned growth limitation of the method was alleviated. FIGS. 3E and 3F illustrate 50 μm and 125 μm core-diameter single-crystal MAPbBr₃ perovskite optical fibers with lengths of several centimetres fabricated with our method by using PTFE cladding. Organometallic perovskite optical fibers with even smaller core diameters and longer lengths can also be achieved through these modifications. According to an embodiment of the present invention, it possible to improve the current aspect-ratio limit for single-crystal perovskite in-solution growth, reported in the prior art(7, 44).

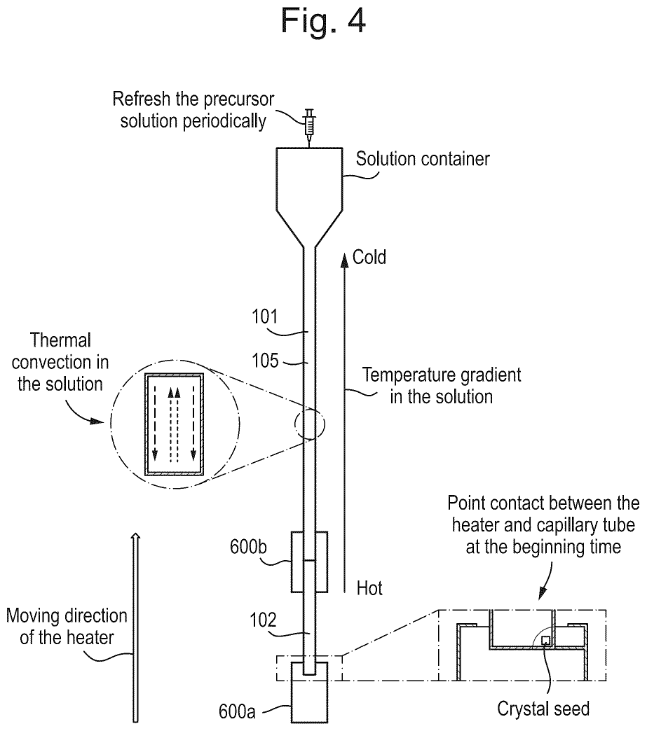

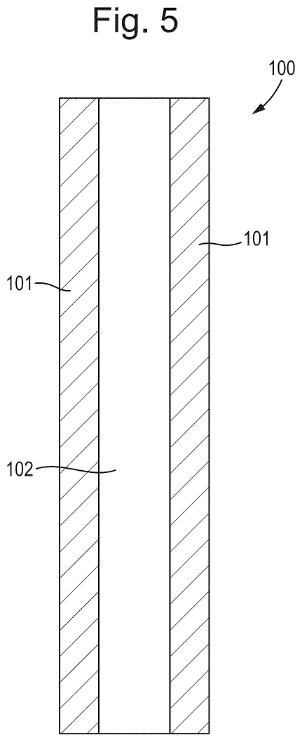

An alternative view of the experimental setup is shown in FIG. 4.

Firstly, the perovskite precursor solution 105 is filled into a capillary tube 101. A movable heater is used to first heat one end of the capillary tube to a certain crystallisation temperature to form the seed perovskite crystal, and then is moved together with the growing crystal for a longer fibre.

To prevent disordered crystallisation, point contact or line contact between the heater and capillary tube is used during this process. In addition, the heater is slowly moved according to the growth speed of the perovskite fibre to ensure the heather is always located at the moving crystal-solution interface, and a constant temperature gradient is maintained at the crystal-solution interface by the moving heater. The heater starts at the bottom of the capillary tube (at position 600a) and moves upwards along with the crystal-solution interface (shown as 600b in FIG. 4). As shown schematically in FIG. 4, the precursor solution may be periodically refreshed to ensure a constant concentration of precursor compounds is maintained in the precursor solution 105. As an alternative to a moving heater, it is possible to provide a series of heating elements along the length of the capillary which are selectively energised in sequence to create a gradually changing heating position.

Eventually the perovskite optical fibre can be formed with a single-crystal perovskite core and fused-silica cladding. The length of the fibre is only limited by the length of the capillary tube, and so a fibre of any desirable length can be formed.

The cross-section of the perovskite core is determined by the shape of the inside of the capillary tube.

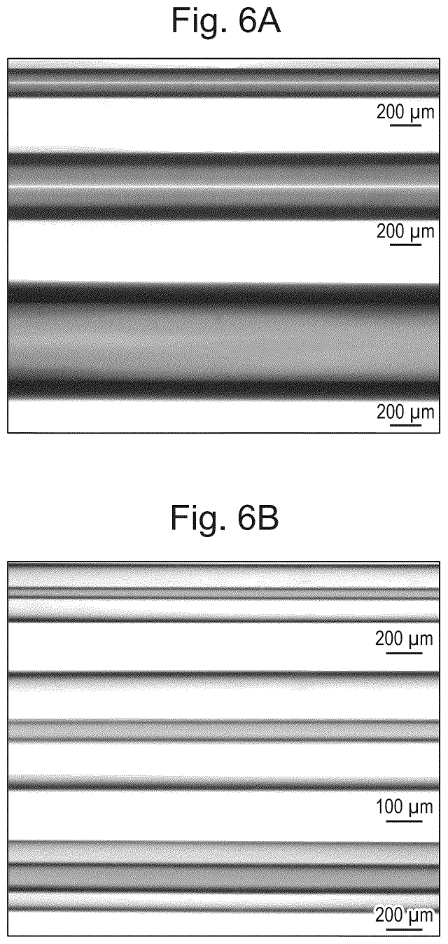

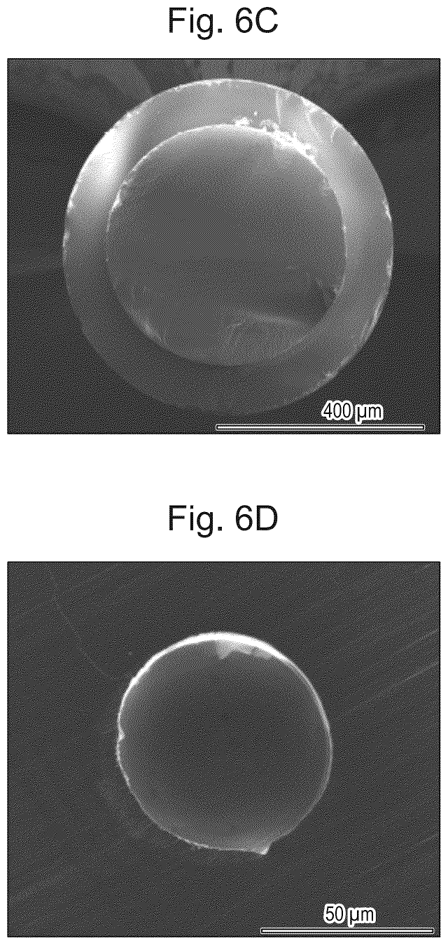

Reference is now made to FIGS. 6A-6D.

FIGS. 6A and 6B show optical microscopy images of MAPbBr₃ single-crystal perovskite optical fibers display high-quality perovskite cores wrapped by the glass cladding and PTFE cladding respectively.

FIGS. 6C and 6D show scanning electron microscope (SEM) images of the fiber cross sections, wherein the fiber is formed according to an embodiment of the present invention. It can be seen that there are no interfacial irregularities at the core/cladding boundary, and no visible grain boundaries and voids on the cross-sectional areas. According to the present invention, high quality single-crystal growth of a perovskite crystal within a capillary is achieved.

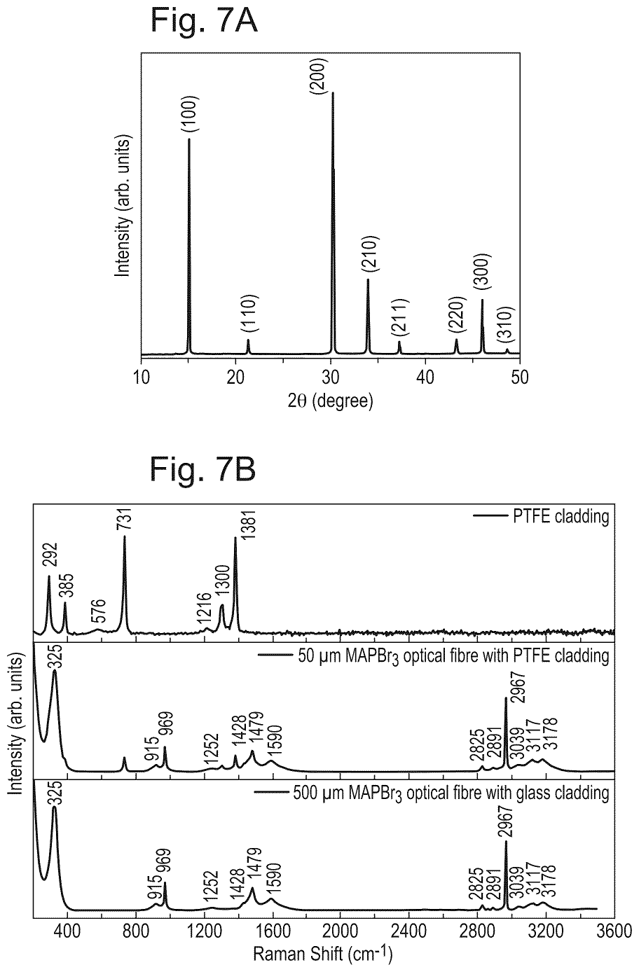

According to the present invention, phase purity of the as-grown MAPbBr₃ single-crystal perovskite optical fibers is achieved, as is confirmed by X-ray diffraction (XRD) performed on powders ground from a 500 μm perovskite core (as shown on FIG. 7A). Raman spectroscopy analyses (with an excitation wavelength of 633 nm) of the 50 μm and 500 μm MAPbBr₃ fibers are as shown in FIG. 7B. The measured results are in good agreement with results obtained for single-crystal MAPbBr₃ perovskites(45), thereby indicating that the present invention achieves a high degree of phase-purity and crystallinity of single-crystal organometallic perovskite fibers.

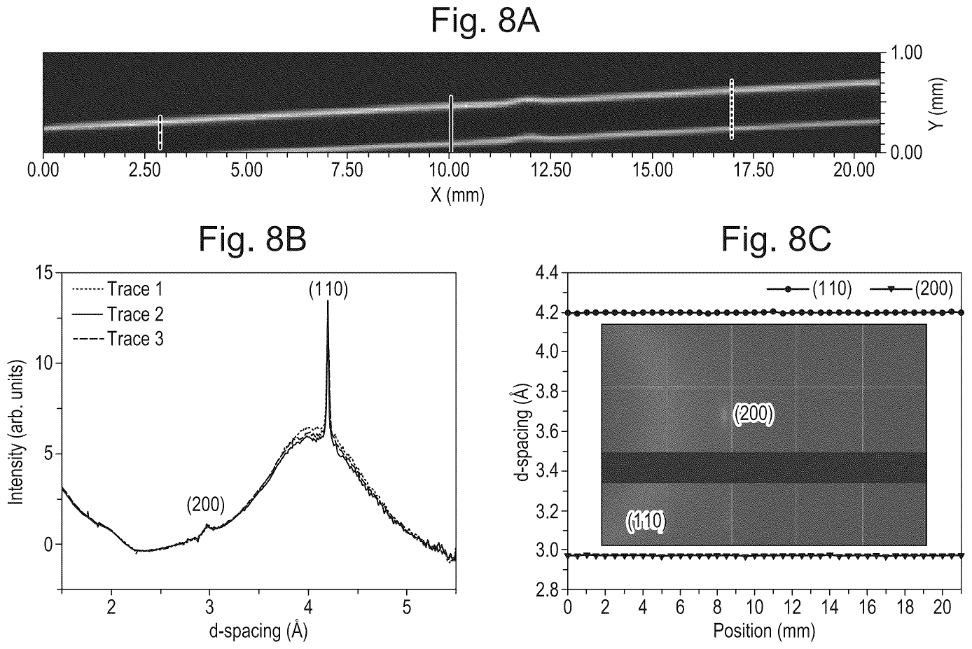

The single-crystal feature of the organometallic perovskite optical fiber was investigated by synchrotron X-ray diffraction (XRD) in transmission mode, as shown on FIG. 8C. For the 300 μm MAPbBr₃ fiber tested, owing to the transmission mode measurement and the cylindrical shape of the fiber, the transmitted X-ray attenuation due to the Pb element in MAPbBr₃ is lowest at the edges (thinnest perovskite material), gradually increases towards the centre of the fiber and peaks along the centre line (thickest perovskite material). A dominated diffraction spot of (110) and an associated weak spot of (200) are observed in the diffraction pattern, as shown in the inset of FIG. 8C.

FIG. 8A is the synchrotron transmission intensity map of (110) peak along the entire single-crystal organometallic perovskite optical fiber, where the edges of the fiber in the map (thinner perovskite material) look brighter compared to the middle region of the fiber.

The d-spacing distributions and corresponding intensities of three different positions in the single-crystal organometallic perovskite fiber are almost the same (as shown on FIG. 8B). FIG. 8C also shows the measured lattice spacings from X-ray diffraction as a function of the position along the fiber. Analyses were conducted on the raw data of XRD by using Dawn Diamond software(30).

FIG. 8A-8C show the results of synchrotron XRD analysis of single-crystal organometallic perovskite optical fibers. FIG. 8A is an intensity map of the (110) peak in the whole organometallic perovskite fiber range through synchrotron XRD analysis, wherein the fiber is formed by a method according to an embodiment of the present invention. FIG. 8B is a graph showing d-spacing distributions and corresponding intensities of three different positions (as shown in FIG. 8A) in the organometallic perovskite fiber. FIG. 8C shows measured lattice spacings obtained from synchrotron XRD as a function of the position along the fiber and the diffraction pattern. The organometallic perovskite optic fiber used in the analyses of FIGS. 8A-8C is formed by a method according to an embodiment of the present invention and has a 300 μm single-crystal MAPbBr₃ fiber.

The results shown on FIGS. 8A-8C suggest that the orientations and d-spacings associated with the (110) and (200) peaks are maintained over the entire 300 μm core and 2.1 cm length of the organometallic perovskite fiber and proves its single-crystal character. Therefore, according to the present invention, a single crystal perovskite core can be growth inside a capillary.

Further, the optical properties of the single-crystal MAPbBr₃ perovskite optical fiber have been studied.

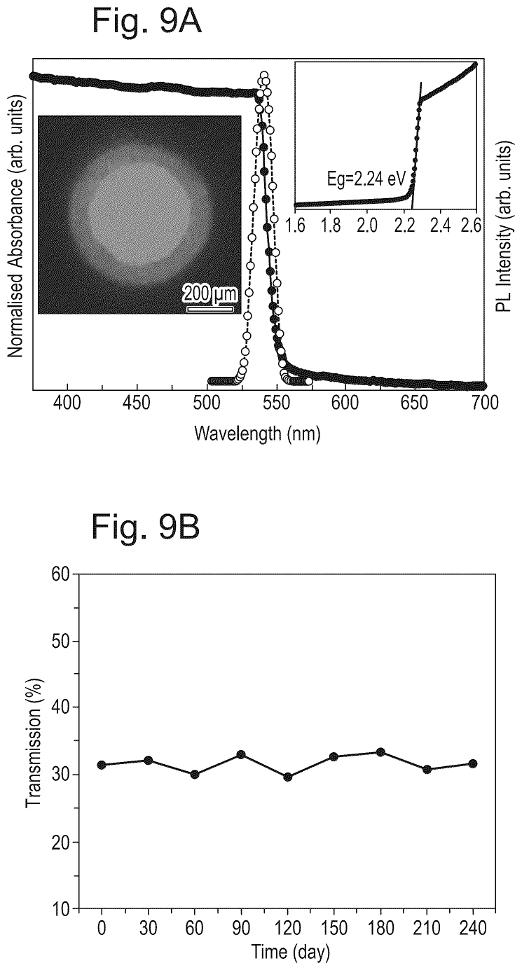

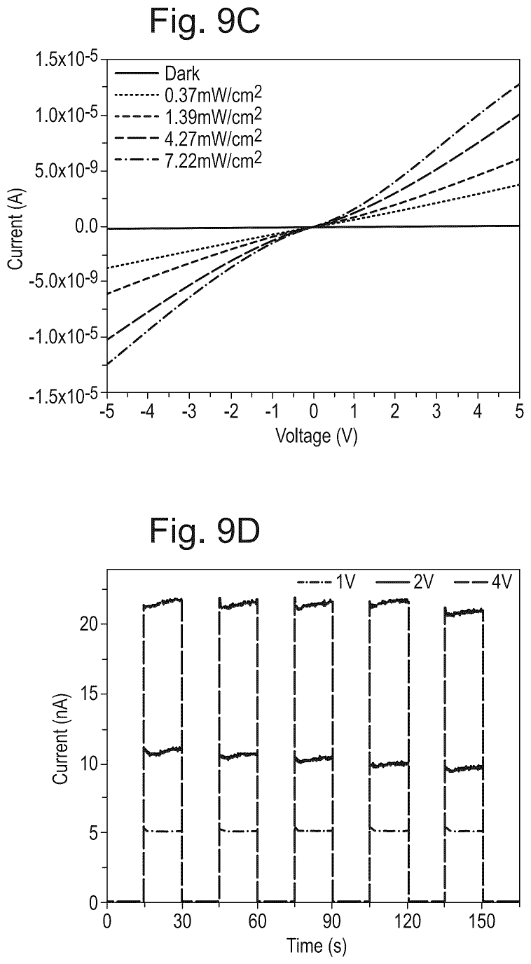

FIGS. 9A-9D characterise the optical properties and photoelectric performance of the single-crystal MAPbBr₃ formed by a method according to an embodiment of the present invention. FIG. 9A shows the steady-state absorbance and photoluminescence properties of a 500 μm MAPbBr₃ optical fiber formed by a method according to an embodiment of the present invention. The left inset of FIG. 9A is a near field image captured by a CCD camera at the 500 μm fiber output. The right inset of FIG. 9A is a Tauc plot and the calculated optical bandgap (2.24 eV) of the fiber. FIG. 9B is the transmission of a 500 μm core-diameter 31 mm-long single-crystal MAPbBr₃ perovskite optical fiber in air over 240 days. FIG. 9C shows I-V curves of 500 μm core-diameter 1 cm-long fiber in dark and under 532 nm with different light irradiation intensities. FIG. 9D shows the dynamic photoresponse of 500 μm core-diameter 1 cm-long fiber under solar simulator (light intensity: 100 mW cm−2) with different bias voltages.

As shown in FIG. 9A, the single-crystal organometallic perovskite fiber material (i.e. the perovskite core) exhibits a sharp absorption edge, and the band gap extracted from a Tauc plot is 2.24 eV.

The single-crystal organometallic perovskite fiber material also shows a narrow PL peak at 540 nm.

The bandgap of an optical fibre formed by a method according to an embodiment of the present invention can be engineered by adjusting the halogens in the precursor solution.

To reduce the formation of defects in the perovskite single-crystal some of the following parameters may be adjusted: lowering the fabrication temperature, minimizing temperature variations, and introducing a non-wetting film on the inner surface of capillary.

The inset of FIG. 9A is the near field image captured by a CCD camera at the 500 μm fiber output with a 785 nm continuous-wave laser input, where well confined guided light within the organometallic perovskite optical fiber core can be seen clearly.

The optical properties of our single-crystal organometallic perovskite optical fiber are found to be stable over a long-period of time, owing to its single-crystal nature and the protection provided by the cladding (wherein the cladding is glass, for example).

As is can be seen from FIG. 9B, the optical fiber transmission loss remains largely unchanged after being stored for 8 months under ambient laboratory conditions. An optic fibre formed by a method according to an embodiment of the present invention exhibits a relatively long life-span.

FIG. 9C illustrated the photoelectric performance is studied of a single crystal MAPbBr3 fiber photodetector (500 μm core-diameter 1 cm-long fiber). FIG. 9C shows the optoelectronic current of the fiber under illumination with 532 nm light at different intensities.

These photocurrent values are much larger than those of a polycrystalline MAPbBr3 milliwire photodetector with similar length due to the superior properties of the single crystal(49).

A stable dynamic photoresponse is also observed in the fiber illuminated by optical pulses from a solar simulator (light intensity: 100 mW cm) with different bias voltages (FIG. 9D), illustrating its photoswitching behaviour. The considerable photocurrent and stable dynamic photoresponse of the single crystal organometallic perovskite fiber indicate its potential applications for in-fiber photodetection.

The flexibility of a single-crystal organometallic perovskite optical fiber can be tailored by controlling its diameter. For a general material:

$${σ}_{st} ∝ \frac{Eh}{2 r}$$

σₛₜ is the maximum stress of the material, E is the Young's modulus, h is the thickness (diameter of the fibre) and r is the bending radius(36). Reducing fiber diameter is beneficial to flexibility.

Fibres formed by a method according to an embodiment of the present invention were tested as follows to characterise their flexibility.

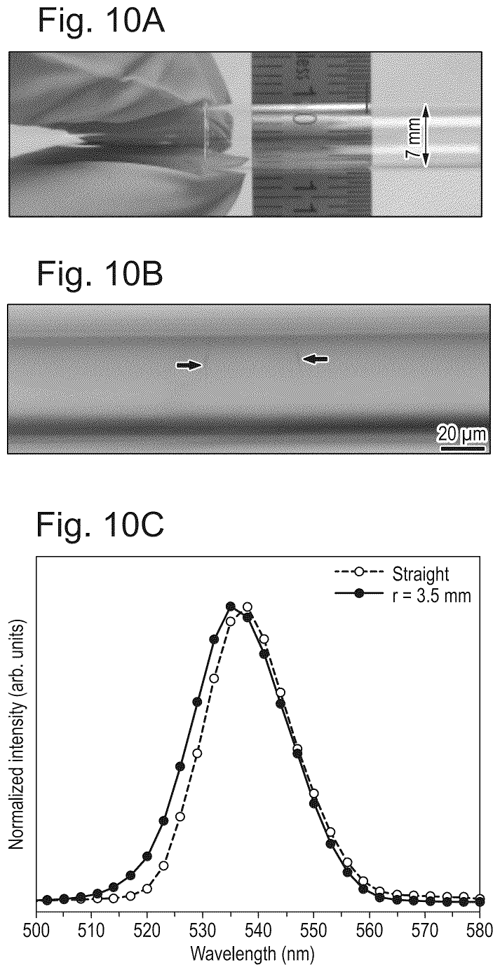

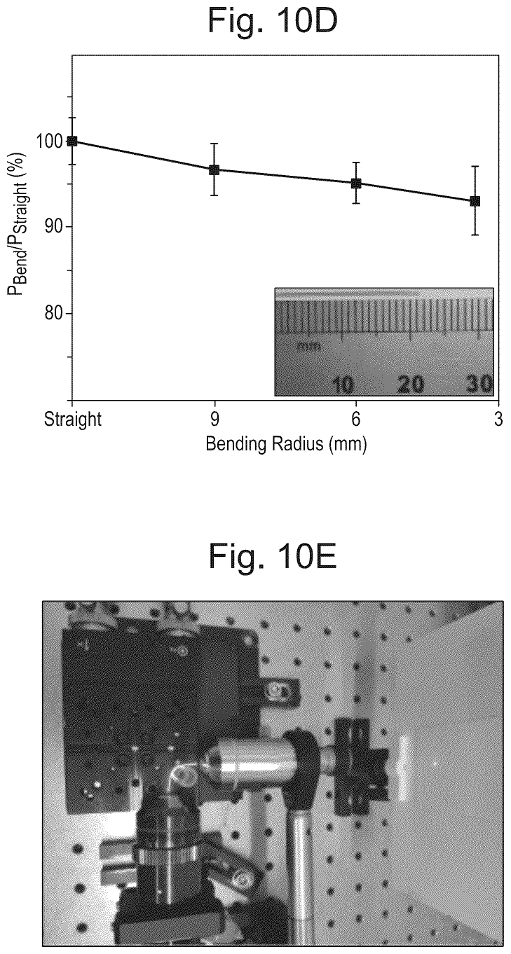

FIGS. 10A-10E illustrate the flexibility performance of a single-crystal MAPbBr₃ optical fibers with PTFE cladding. FIG. 10A is a photo of a 50 μm core-diameter single-crystal MAPbBr3 perovskite optical fiber wrapped around a small tube (7 mm in diameter) to show its flexibility. FIG. 10B is an optical microscopy image of the microcracks observed in 50 μm core-diameter MAPbBr₃ perovskite optical fiber when the bending radius reaches about 3 mm. FIG. 10C is a normalized confocal photoluminescence spectra of the 50 μm core-diameter MAPbBr₃ perovskite optical fiber with the bending radius of ∞ (i.e. straight fiber) and 3.5 mm. The organometallic perovskite fiber was wrapped around on a small tube with the diameter of 7 mm for the PL measurement, and the measured bending tip should bear a tensile strain. FIG. 10D shows the output power of a 50 μm core-diameter 21 mm-long MAPbBr₃ fiber as a function of the bending radius under the illumination of 633 nm laser. The bottom right inset of FIG. 10D is a photograph of the 50 μm core-diameter 21 mm-long MAPbBr₃ fiber used for the test. FIG. 10E is a photo of 633 nm light transmission in the 50 μm MAPbBr₃ optical fiber with the bending radius of 3.5 mm.

To measure the minimal bending radius, the organometallic perovskite fibers with PTFE cladding were wrapped around cylinders or cones with various diameters. As shown in FIG. 10A, the 50 μm-core-diameter MAPbBr₃ perovskite optical fiber with PTFE cladding was wrapped around a small tube (7 mm in diameter) without any observable microcrack, demonstrating good flexibility. The minimal bending radii are 3.5 mm and 15 mm for the 50 μm-core-diameter and 125 μm-core-diameter MAPbBr₃ perovskite optical fibers, respectively. The minimal bending radius of our 50 μm fiber is comparable with 2-μm-thick single-crystal organometallic perovskite thin films(36), and is suitably small for most applications of such fibers.

FIG. 10B illustrates the microcracks observed in a 50 μm core-diameter MAPbBr₃ perovskite optical fiber when the bending radius reaches about 3 mm.

FIG. 10C illustrates the normalized confocal PL spectra of the 50 μm MAPbBr₃ fiber with the bending radius of ∞ (i.e. a straight fiber) and 3.5 mm, a blueshift (3 nm) of the PL peak is observed on the bending tip of the fiber, due to the increased band gap of this material under tensile strain(50).

The single-crystal fiber according to the present invention demonstrates a strain-induced PL shift of an organometallic halide perovskite caused by mechanical deformation.

This mechanical deformation-induced PL shift behaviour of the organometallic perovskite fiber makes it suitable for applications as a stress sensor and wavelength-tuneable light source.

The light transmission properties as a function of bending radius of a single-crystal organometallic perovskite optical fiber according to the present invention is shown in FIG. 10D.

The output power shows a small decrease with the reduction of bending radius, which indicates a small bending loss of the 50 um fiber even at 3.5 mm bending radius. This could be attributed to the good flexibility and large refractive index of the MAPbBr3 core(54). A photo of the light transmission behaviour is shown in FIG. 10E.

FIG. 12A is a schematic diagram of an optical switch comprising optic fibres formed by a method according to an embodiment of the present invention. All-optical switch, in which the signal light can be cut off or put through by a control light, is a fundamental component for ultrafast optical communication networks as well as optical computing systems.

A key challenge of this technology is that tiny nonlinear optical properties in materials require comprehensive trade-off between speed, energy, footprint, and dissipation. Due to the strong optical confinement and light guidance in waveguides, the high optical intensities and long interaction lengths can be achieved, leading to the enhancement of nonlinear optical effects.

Organometallic halide perovskites have excellent optoelectronic and nonlinear optical properties. A single-crystal perovskite optical fibre according to the present invention also provides a waveguide platform to achieve high optical intensities and long interaction lengths for optical switch applications.

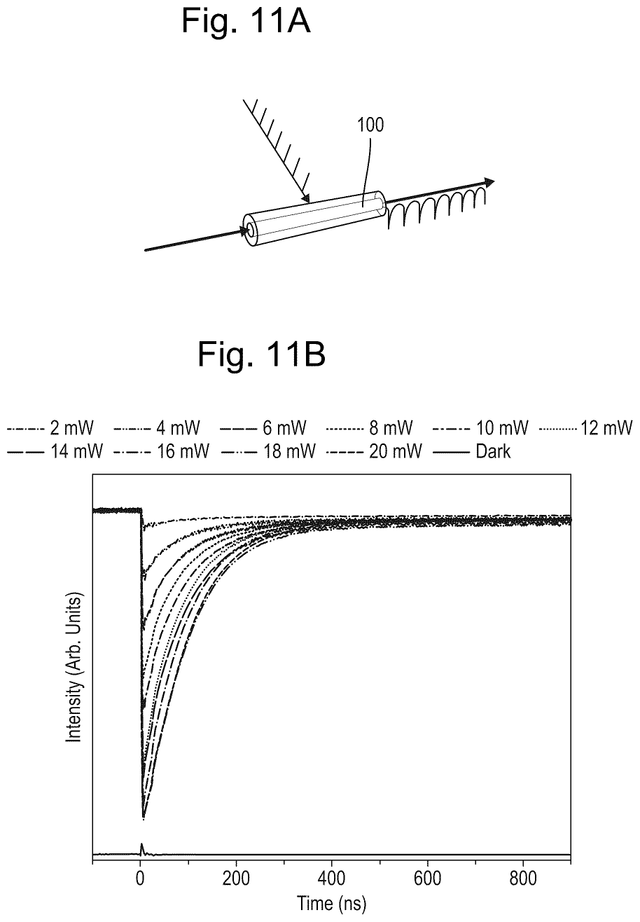

Through the all-optical switches based on perovskite optical fibres, the propagation states of signal light can be modulated by using a control light, as shown in FIG. 11A. The light propagating along optic fibre 100 is shown by a bold line, and the control light is shown by a thin line. The incoming light modulates the light as is propagates along the length of the optic fibre 100.

FIG. 11B shows the performance of an all-optical switch through the free carrier plasma-dispersion effect in a perovskite optical fibre formed according to an embodiment of the present invention. FIG. 11B shows that the 632 nm continuous wave (CW) signal light is modulated (switched) by an 840 nm femtosecond pulse laser at different power levels through the free carrier plasma-dispersion effect in our perovskite optical fibre. A modulation depth up to 95% and a modulation speed around 100-200 ns are achieved.

### Materials and Methods

### [Materials and Methods]

An example of a method according to the present invention is described below.

### [[Chemicals and Reagents]]

Lead bromide (98%), lead chloride (98%), DMSO (anhydrous, 99.9%) and DMF (anhydrous, 99.8%) were purchased from Sigma Aldrich®. MABr and MACl were purchased from Ossila®. All chemicals were used as received without any further purification.

### [[Synthesis of Single-Crystal Organometallic Perovskite Optical Fibers]]

For the synthesis of single-crystal MAPbBr₃ fibers, PbBr2 and MABr (1/1 by molar, 1 M) were dissolved in DMF by magnetic stirring at room temperature. The solution was filtered using PTFE filter with 0.2 μm pore size. The organometallic perovskite precursor solution was filled into the silica capillary tubes and PTFE capillary tubes of different inner diameters (50 μm, 100 μm, 125 μm, 300 μm, 500 μm and 1000 μm). The capillary tubes with precursor solution were sealed at one end to prevent leakage. Then the capillary tube was fixed to ensure the tube axis is perpendicular to the ground with the sealed end down, as shown FIG. 1.

A heat transfer block was placed on the hotplate and had a line contact with the capillary. The length of liquid column in the capillary that contacts with the block was controlled to a couple of millimeters at the beginning to prevent disordered nucleation. This line contact in combination with the limited heating region prevented disordered nucleation in other sites. At first, the solution at bottom end was heated to 80° C. (T₁) and after a few hours the seed organometallic perovskite crystal was formed. Then the hotplate temperature was reduced and kept at (T₂) 60° C. for the single-crystal fiber growth. In addition, extra heat transfer blocks were added on top of each other according to the growth speed of the single-crystal organometallic perovskite optical fiber to ensure the top block was always located at the crystal-solution interface, and therefore a constant temperature gradient was maintained in front of the crystal-solution interface by the changed heating position. This temperature gradient provided ion diffusion for the continuous growth of organometallic perovskite core due to the thermal convection in the solution, and also inhibited other nucleation sites because of the unsaturation at relative lower temperature zones outside the crystal-solution interface. The precursor solution was refreshed periodically during the crystal growth to produce longer organometallic perovskite optical fiber. A solution container can be attached to the top end of the capillary tube for the convenience of solution renewal. Eventually the organometallic perovskite optical fiber of a certain length was formed with a single-crystal organometallic perovskite core and a cladding. The growth rates are about 4 mm/day and 1.5 mm/day for the single-crystal MAPbBr₃ perovskite optical fibers (glass cladding) with the inner diameters of 500 μm and 300 μm, respectively. The precursor solution may be refreshed when the growth rate becomes lower than normal value. The growth rate of 100 μm fiber (glass cladding) is about 0.5 mm/day at the very beginning and decreases gradually during the growth process until finally stopped (the lengths we currently can achieve are limited to several millimeters). The growth rate is about 0.5-0.7 mm/day for the MAPbBr₃ perovskite fibers (PTFE cladding) with the inner diameters of 50 μm and 125 μm. For the synthesis of single-crystal MAPbBr2.5Cl0.5 fibers, MABr (0.112 g), PbBr2 (0.275 g) and PbCl2 (0.070 g) were dissolved in DMF (1 ml) as the precursor solution. The temperatures for nucleation and crystal growth are 70° C. and 50° C., respectively. For the synthesis of single-crystal MAPbCl3 fibers, PbCl2 and MACl (1/1 by molar, 1 M) were dissolved in DMF-DMSO (1:1 v/v) as the precursor solution. The temperatures for nucleation and crystal growth are 50° C. and 40° C., respectively.

The precursor solution supplied to the solution during crystal growth may be the same as the initial solution used. This may lead to optimised growth speed. Alternatively, the precursor solution added during crystal growth may include a different precursor element to form a different perovskite crystal as well as heterostructures in the crystal fibre.

### [Material Characterization]

Optical images were captured using Olympus BX60 upright compound microscope. The SEM images were obtained using FEI Nova NanoSEM 650, operating in low-vacuum mode with an accelerating voltage of 5 kV.

The chemical composition was determined by means of EDX (attached to FEI Nova NanoSEM 650) at voltage of 10 kV.

X-ray powder diffraction data were collected using a Bruker D8 Advance diffractometer in Bragg-Brentano geometry and operating with Ni filtered Cu Kα radiation (λ=1.5418 Å) over the 2θ range from 5° to 70°.

Raman spectroscopies were obtained using a Renishaw inVia confocal Raman microscope at an excitation wavelength of 633 nm to avoid the fluorescence ebackground.

The synchrotron X-ray diffraction measurements were undertaken using the beam line I18 at the Diamond Light Source, based at Didcot Oxfordshire (UK). The instrument was operated in the transmission model at 13 keV with a beam spot diameter of ≈25 μm (300 μm core-diameter fiber) and 2.5 μm (50 μm core-diameter fiber). About the 300 μm fiber, the Bragg diffracted X-rays were measured at 25 μm and 100 μm intervals along the width and length of the fiber, respectively. As for the 50 μm fiber, the X-rays were measured at 10 μm and 250 μm intervals along the width and length. The steady-state absorption and photoluminescence were recorded using Perkin Elmer Lambda950 UV-vis spectrophotometer with an integrating sphere and Perkin Elmer LS55 spectrofluorometer, respectively.

### [Optical Loss Measurements]

A 785 nm laser (LML-785.0CB-03 Laser from PD-LD INC.) was used for loss measurements using the cutback method. Before the loss measurement, the fiber was polished using normal procedures without water. Light was coupled into the fiber in free space using a 40×/0.75 NA objective lens and the transmitted light was collected onto the Thorlabs PM110D power meter with a photodiode sensor and the output image was captured by a CCD camera (uEye UI-2230-C) with a 20x objective lens. The fiber output end was sequentially removed by 3 mm several time via cutting and polishing during the cutback measurements.

### [Photodetector Fabrication and Measurements]

For photodetector fabrication, the two ends of a 500 μm core-diameter 1 cm-long MAPbBr₃ fiber were coated by silver conductive paint. After the silver paint dried up, conductive copper tapes were attached to both ends of the fiber and fixed by the silver paint. The I-V curves and dynamic photo response of the fiber photodetector were measured using Keithley 2400 under illumination of a 532 nm laser diode and solar simulator respectively.

### [Optical Transmission Measurements of Flexible Fiber]

The fiber was cut by sharp blades and used for the measurements directly. A 633 nm laser was coupled into the fiber in free space using a 60x/0.70 NA objective lens and the transmitted light was collected onto the Thorlabs PM110D power meter with a photodiode sensor.

### [Confocal PL Spectra Measurements]

Confocal PL spectra of flexible organometallic perovskite fibers were measured by Zeiss LSM 710 Confocal Microscope at an excitation wavelength of 405 nm. The fibers were wrapped around on a small tube to measure the PL of the fibers under bending state.

### [Nonlinear-Transmission Experiments]

To study the MPA properties of MAPbBr₃ optical fibers, a Ti:sapphire laser (Brand: Coherent Micra; Central wavelength: 798 nm; FWHM: 113 nm; Pulse width: ˜50 fs; Repetition rate: 80 MHz; Beam diameter: 0.42 mm) was used to pump the organometallic perovskite optical fibers.

The fibers were mounted on a precision stage for alignment along 3 axes. The light was focussed tightly using a long focal length lens (150 mm). The fibers were then aligned with the laser beam.

The output light from the fibers was collected by a large numerical aperture objective and focussed by a second lens onto a fiber coupler to an Ocean Optics spectrometer. A reflective filter for 800 nm light was placed in between the lens and the fiber coupler to remove the majority of the pump beam.

In summary, according to the present invention there is provided a solution-processed and scalable method for one-directional single-crystal organometallic perovskite growth and the an organometallic perovskite optical fibre based on this. This method is universal and can be extended to other types of organometallic perovskite materials.

The single-crystal organometallic perovskite optical fibres exhibit low transmission loss and good stability under ambient conditions. An optical fiber with a 50 um core-diameter with soft PTFE cladding is mechanically flexible, and the low transmission power decrease after bending indicates a low bending loss of the 50 um fibre even at 3.5 mm bending radius.

These flexible fibres are convenient for mechanical deformation-induced strains to be generated, as shown by the mechanical deformation-induced PL shift in organometallic perovskites.

The single-crystal organometallic perovskite optical fibres reported in this work may find applications in the fields of fibre optics and optoelectronics, such as optical modulation, up-conversion PL, fibre photodetector, sensing, etc.

Having described the invention it will be appreciated that variations may be made on the above described embodiments, which are not intended to be limiting. The invention is defined in the appended claims and their equivalents.

### REFERENCES AND NOTES

1. M. M. Lee, J. Teuscher, T. Miyasaka, T. N. Murakami, H. J. Snaith, Efficient Hybrid Solar Cells Based on Meso-Superstructured Organometal Halide Perovskites. Science 338, 643-647 (2012).
2. W. Li et al., Chemically diverse and multifunctional hybrid organic-inorganic perovskites. Nature Reviews Materials 2, 16099 (2017).
3. C. Wehrenfennig, G. E. Eperon, M. B. Johnston, H. J. Snaith, L. M. Herz, High Charge Carrier Mobilities and Lifetimes in Organolead Trihalide Perovskites. Advanced Materials 26, 1584-1589 (2014).
4. M. R. Filip, G. E. Eperon, H. J. Snaith, F. Giustino, Steric engineering of metal-halide perovskites with tunable optical band gaps. Nature Communications 5, 5757 (2014).
5. N. J. Jeon et al., Compositional engineering of perovskite materials for high-performance solar cells. Nature 517, 476-480 (2015).
6. Z.-K. Tan et al., Bright light-emitting diodes based on organometal halide perovskite. Nature Nanotechnology 9, 687-692 (2014).
7. Z. Yang et al., High-Performance Single-Crystalline Perovskite Thin-Film Photodetector. Advanced Materials 30, 1704333 (2018).
8. H. Zhu et al., Lead halide perovskite nanowire lasers with low lasing thresholds and high quality factors. Nature Materials 14, 636-642 (2015).
9. T.-C. Wei et al., Nonlinear Absorption Applications of CH3NH3PbBr3 Perovskite Crystals. Advanced Functional Materials 28, 1707175 (2018).
10. F. O. Saouma, C. C. Stoumpos, J. Wong, M. G. Kanatzidis, J. I. Jang, Selective enhancement of optical nonlinearity in two-dimensional organic-inorganic lead iodide perovskites. Nature Communications 8, 742 (2017).
11. Y.-M. You et al., An organic-inorganic perovskite ferroelectric with large piezoelectric response. Science 357, 306-309 (2017).
12. W. Tang et al., Substitutional doping of hybrid organic-inorganic perovskite crystals for thermoelectrics. Journal of Materials Chemistry A 8, 13594-13599 (2020).
13. D. Shi et al., Low trap-state density and long carrier diffusion in organolead trihalide perovskite single crystals. Science 347, 519-522 (2015).
14. Y. Dang et al., Bulk crystal growth of hybrid perovskite material CH3NH3PbI3. CrystEngComm 17, 665-670 (2015).
15. F. Yao et al., Room-temperature liquid diffused separation induced crystallization for high-quality perovskite single crystals. Nature Communications 11, 1194 (2020).
16. M. I. Saidaminov et al., High-quality bulk hybrid perovskite single crystals within minutes by inverse temperature crystallization. Nature Communications 6, 7586 (2015).
17. P. Wang et al., Mid-infrared Raman sources using spontaneous Raman scattering in germanium core optical fibers. Applied Physics Letters 102, 011111 (2013).
18. Y. P. Huang, L. A. Wang, In-line silicon Schottky photodetectors on silicon cored fibers working in 1550 nm wavelength regimes. Applied Physics Letters 106, 191106 (2015).
19. P. Mehta, N. Healy, T. D. Day, J. V. Badding, A. C. Peacock, Ultrafast wavelength conversion via cross-phase modulation in hydrogenated amorphous silicon optical fibers. Opt. Express 20, 26110-26116 (2012).
20. M. Bayindir et al., Metal-insulator-semiconductor optoelectronic fibres. Nature 431, 826-829 (2004).
21. F. A. Martinsen et al., Silicon-core glass fibres as microwire radial-junction solar cells. Scientific Reports 4, 6283 (2014).
22. T. Zhang et al., High-performance, flexible, and ultralong crystalline thermoelectric fibers. Nano Energy 41, 35-42 (2017).
23. S. Egusa et al., Multimaterial piezoelectric fibres. Nature Materials 9, 643-648 (2010).
24. D. Homa, A. Cito, G. Pickrell, C. Hill, B. Scott, Silicon fiber with p-n junction. Applied Physics Letters 105, 122110 (2014).
25. J. Ballato et al., Silicon optical fiber. Opt. Express 16, 18675-18683 (2008).
26. P. J. A. Sazio et al., Microstructured Optical Fibers as High-Pressure Microfluidic Reactors. Science 311, 1583-1586 (2006).
27. John Ballato et al., Binary III-V semiconductor core optical fiber. Opt. Express 18, 4972-4979 (2010).
28. J. R. Sparks et al., Zinc Selenide Optical Fibers. Advanced Materials 23, 1647-1651 (2011).
29. H. K. Tyagi, M. A. Schmidt, L. Prill Sempere, P. S. J. Russell, Optical properties of photonic crystal fiber with integral micron-sized Ge wire. Opt. Express 16, 17227-17236 (2008).
30. N. Healy et al., CO2 Laser-Induced Directional Recrystallization to Produce Single Crystal Silicon-Core Optical Fibers with Low Loss. Advanced optical Materials 4, 1004-1008 (2016).
31. X. Ji et al., Single-Crystal Silicon Optical Fiber by Direct Laser Crystallization. ACS Photonics 4, 85-92 (2017).
32. X. Ji et al., Single-Crystal Germanium Core Optoelectronic Fibers. Advanced optical Materials 5, 1600592 (2017).
33. S. A. Veldhuis et al., Perovskite Materials for Light-Emitting Diodes and Lasers. Advanced Materials 28, 6804-6834 (2016).
34. G. Xing et al., Low-temperature solution-processed wavelength-tunable perovskites for lasing. Nature Materials 13, 476-480 (2014).
35. J. Zhang et al., Solution-Processed Epitaxial Growth of Arbitrary Surface Nanopatterns on Hybrid Perovskite Monocrystalline Thin Films. ACS Nano 14, 11029-11039 (2020).
36. Y. Lei et al., A fabrication process for flexible single-crystal perovskite devices. Nature 583, 790-795 (2020).
37. W. Mao et al., Controlled Growth of Monocrystalline Organo-Lead Halide Perovskite and Its Application in Photonic Devices. Angewandte Chemie International Edition 56, 12486-12491 (2017).
38. Z. Wang et al., Wavelength-tunable waveguides based on polycrystalline organic-inorganic perovskite microwires. Nanoscale 8, 6258-6264 (2016).
39. P. Liu et al., Organic-Inorganic Hybrid Perovskite Nanowire Laser Arrays. ACS Nano 11, 5766-5773 (2017).
40. N. Kurahashi, H. Mizuno, F. Sasaki, H. Yanagi, Whispering Gallery Mode Lasing from CH3NH3PbBr3/PEO Composites Grown in a Microcapillary. The Journal of Physical Chemistry C 124, 3242-3249 (2020).
41. Z. Chen et al., Thin single crystal perovskite solar cells to harvest below-bandgap light absorption. Nature Communications 8, 1890 (2017).
42. C. Bi et al., Non-wetting surface-driven high-aspect-ratio crystalline grain growth for efficient hybrid perovskite solar cells. Nature Communications 6, 7747 (2015).
43. C. Sendner, D. Horinek, L. Bocquet, R. R. Netz, Interfacial Water at Hydrophobic and Hydrophilic Surfaces: Slip, Viscosity, and Diffusion. Langmuir 25, 10768-10781 (2009).
44. Y.-X. Chen et al., General Space-Confined On-Substrate Fabrication of Thickness-Adjustable Hybrid Perovskite Single-Crystalline Thin Films. Journal of the American Chemical Society 138, 16196-16199 (2016).
45. L.-Q. Xie et al., Organic-inorganic interactions of single crystalline organolead halide perovskites studied by Raman spectroscopy. Physical Chemistry Chemical Physics 18, 18112-18118 (2016).
46. Y. Liu et al., Two-Inch-Sized Perovskite CH3NH3PbX3 (X=Cl, Br, I) Crystals: Growth and Characterization. Advanced Materials 27, 5176-5183 (2015).
47. S. Amari, J.-M. Verilhac, E. Gros D'Aillon, A. Ibanez, J. Zaccaro, Optimization of the Growth Conditions for High Quality CH3NH3PbBr3 Hybrid Perovskite Single Crystals. Crystal Growth & Design 20, 1665-1672 (2020).
48. Z. Ni et al., Resolving spatial and energetic distributions of trap states in metal halide perovskite solar cells. Science 367, 1352-1358 (2020).
49. F. Chen et al., Self-Assembled Growth of Ultrastable CH3NH3PbBr3 Perovskite Milliwires for Photodetectors. ACS Applied Materials & Interfaces 10, 25763-25769 (2018).
50. C. Zhu et al., Strain engineering in perovskite solar cells and its impacts on carrier dynamics. Nature Communications 10, 815 (2019).
51. Y. Chen et al., Strain engineering and epitaxial stabilization of halide perovskites. Nature 577, 209-215 (2020).
52. D.-J. Xue et al., Regulating strain in perovskite thin films through charge-transport layers. Nature Communications 11, 1514 (2020).
53. D. Liu et al., Strain analysis and engineering in halide perovskite photovoltaics. Nature Materials 20, 1337-1346 (2021).
54. A. M. A. Leguy et al., Experimental and theoretical optical properties of methylammonium lead halide perovskites. Nanoscale 8, 6317-6327 (2016).
55. T. Sarma, P. K. Panda, P. T. Anusha, S. V. Rao, Dinaphthoporphycenes: Synthesis and Nonlinear Optical Studies. Organic Letters 13, 188-191 (2011).
56. A. A. Said et al., Determination of bound-electronic and free-carrier nonlinearities in ZnSe, GaAs, CdTe, and ZnTe. J. Opt. Soc. Am. B 9, 405-414 (1992).
57. P. A. Kurian, C. Vijayan, C. S. S. Sandeep, R. Philip, K. Sathiyamoorthy, Two-photon-assisted excited state absorption in nanocomposite films of PbS stabilized in a synthetic glue matrix. Nanotechnology 18, 075708 (2007).
58. F. Wu et al., Two-photon absorption and two-photon assisted excited-state absorption in CdSe0.3S0.7 quantum dots. Journal of Optics A: Pure and Applied Optics 11, 065206 (2009).
59. B. Gu, K. Lou, H.-T. Wang, W. Ji, Dynamics of two-photon-induced three-photon absorption in nanosecond, picosecond, and femtosecond regimes. Opt. Lett. 35, 417-419 (2010).
60. A. Cutolo, M. Iodice, P. Spirito, L. Zeni, Silicon electro-optic modulator based on a three terminal device integrated in a low-loss single-mode SOI waveguide. Journal of Lightwave Technology 15, 505-518 (1997).
61. F. Ye et al., Low-Temperature Soft-Cover Deposition of Uniform Large-Scale Perovskite Films for High-Performance Solar Cells. Advanced Materials 29, 1701440 (2017).
62. E. L. Koschmieder, M. I. Biggerstaff, Onset of surface-tension-driven Bénard convection. Journal of Fluid Mechanics 167, 49-64 (1986).
63. Y. Rakita et al., Tetragonal CH3NH3PbI3 is ferroelectric. Proceedings of the National Academy of Sciences 114, E5504-E5512 (2017).
64. M. U. Rothmann et al., Direct observation of intrinsic twin domains in tetragonal CH3NH3PbI3. Nature Communications 8, 14547 (2017).

1-26. (canceled)

27. A method for the growth of single-crystal perovskite optical fibres, the fibres having a cladding and a perovskite core, the method comprising:
continuously growing the perovskite core along an axial direction of a capillary filled with perovskite precursor solution,
wherein the axial directional growth of the perovskite core is realised by capillaries, which limit growth of the perovskite core in the radial direction,
wherein the method is controlled by gradually changing heating position and localised contact of a heating block with the capillary, and
the capillary forms the cladding of the single-crystal organometallic perovskite optical fibre.

28. The method of claim 27 being a solution-processed, space-confined, inverse temperature crystallisation, localised translational heating method.

29. The method of claim 27, wherein the length of the fibre is controlled by the heating method.

30. The method of claim 27 wherein the perovskite is an organometallic perovskite.

31. The method of claim 27, wherein the cross section of the perovskite fibre core corresponds to an inner diameter of the capillary.

32. The method of claim 27, wherein the capillary is made from a material which has a refractive index that is lower than the refractive index of the perovskite core.

33. The method of claim 27 wherein the cladding material is glass or polytetrafluoroethylene.

34. A method for the growth of a single-crystal organometallic perovskite optical fibre having a core and cladding, comprising the steps of:
forming a perovskite precursor solution;
filtering the solution;
filling the perovskite precursor solution into capillary tubes;
sealing the capillary tubes at one end;
placing a heat transfer block on a hotplate, such that the heat transfer block has a line contact with the capillary;
heating the solution at a predetermined position on the capillary until a seed perovskite crystal is formed;
reducing the heating temperature such that single-crystal fibre growth of the precursor solution takes place;
translating the predetermined position according to the growth speed of the single-crystal organometallic perovskite optical fibre to ensure heating position is located at the crystal-solution interface, such that a constant temperature gradient is maintained in front of the crystal-solution interface by the changed heating position.

35. The method of claim 34, further comprising a step of supplying fresh precursor perovskite solution into the capillary tubes at the other end during growth of the single crystal.

36. The method according to claim 34, wherein the single-crystal organometallic perovskite optical fibre has a CH₃NH₃PbBr₃ core, and the organometallic perovskite precursor solution is formed by dissolving PbBr₂ and CH₃NH₃Br₃ (1/1 by molar, 1 M) in DMF by magnetic stirring at room temperature.

37. The method according to claim 35, wherein the single-crystal organometallic perovskite optical fibre has a CH3NH3PbBr3 core, and the organometallic perovskite precursor solution is formed by dissolving PbBr2 and CH3NH3Br3 (1/1 by molar, 1 M) in DMF by magnetic stirring at room temperature.

38. The method according to claim 34, wherein the single-crystal organometallic perovskite optical fibres have a CH₃NH₃PbX₃ core, wherein X is chlorine or iodine, and the precursor solution is formed by dissolving PbX₂ and CH₃NH₃X (1/1 by molar, 1 M) in DMF by magnetic stirring at room temperature, and/or wherein the solution is filtered using a PTFE filter with 0.2 μm pore size.

39. The method according to claim 34, wherein the solution is heated at the sealed end of the capillary tube to 80° C. for a few hours, such that the seed organometallic perovskite crystal is formed.

40. The method according to claim 34, wherein the hotplate temperature is reduced to 60° C. such that single-crystal fibre growth of the precursor solution takes place.

41. The method according to claim 34, wherein the precursor solution is refreshed periodically during the crystal growth to produce longer organometallic perovskite optical fibre, wherein optionally, the precursor solution is refreshed when the growth rate of the crystal becomes lower than normal value.

42. The method according to claim 34, wherein the capillary tubes are made of silica or PTFE.

43. The method according to claim 34, wherein the diameter of the capillary is equal to or greater than 50 μm and equal to or less than 1000 μm.

44. An optical fibre manufactured according to the method of claim 27.

45. An optical fibre manufactured according to the method of claim 34.

46. An optical fibre comprising a cladding and a core, wherein the core is a single-crystal organometallic halide perovskite.

47. The optical fibre according to claim 46, wherein the cladding is silica or PTFE, and optionally, wherein the core is a single crystal CH₃NH₃PbBr₃.

48. An optical switch comprising the optical fibres of claim 47.
